(19) United States
(12) Patent Application Publication
(10) Pub. No.: US 2019/0132711 A1
(43) Pub. Date: May 2, 2019

(54) SYSTEMS AND ASSOCIATED METHODS FOR SHARING IMAGE FILES

(71) Applicant: CHENGDU CK TECHNOLOGY CO., LTD., Chengdu (CN)

(72) Inventor: Xianliang ZHANG, Chengdu (CN)

(73) Assignee: Chengdu CK Technology Co., Ltd., Chengdu (CN)

(21) Appl. No.: 16/088,414

(22) PCT Filed: Mar. 28, 2017
(86) PCT No.: PCT/CN2017/078402

§ 371 Date: Sep. 25, 2018

(30) Foreign Application Priority Data
Mar. 31, 2016 (CN) 201610197810.X

(51) Int. Cl. H04W 4/21; H04N 5/225; H04N 5/232

(52) U.S. Cl. CPC H04W 4/21; H04N 5/23206; H04N 5/225

(57) ABSTRACT

The present disclosure relates to methods and associated apparatuses that enable a user to initiate a process of sharing image files. The method includes, for example, (1) generating an instruction from a user operation via an input device of a control device; (2) generating, by an instruction generating component of the control device, a signal in response to the instruction; (3) encoding the signal to form an encoded signal; (4) transmitting, by a first transmitter of the control device, the encoded signal to a receiver of a sports camera under a first communication protocol; (5) decoding, by a decoder of the sports camera, the received encoded signal to form a decoded signal; and (6) transmitting, in response to the decoded signal, by a second transmitter of the sports camera, the image item stored in a storage device to a broadcasting server according to user account information stored in the storage device under a second communication protocol.

### CROSS-REFERENCE TO RELATED APPLICATIONS

This application claims the benefit of Chinese Patent Application No. 201610197810X, filed Mar. 31, 2016 and entitled “SPORTS CAMERA SYSTEMS AND METHODS FOR ONE-CLICK SHARING,” the contents of which are hereby incorporated by reference in its entirety.

### BACKGROUND

It has become more and more popular to use sports cameras to collect images of outdoor activities. After collecting these images, a user may want to share the collected images with friends, colleagues, or the public. It could be challenging for a user, who has already been occupied with image-collecting tasks, to timely and properly share the collected images. To address such a need, a corresponding system should be easy to operate, convenient to carry, and can be operated in an intuitive/straightforward fashion. Therefore, it is advantageous to have a sports camera system that can provide above-mentioned functions.

### BRIEF DESCRIPTION OF THE DRAWINGS

Embodiments of the disclosed technology will be described and explained through the use of the accompanying drawings.

FIG. 1 is a schematic diagram illustrating a system in accordance with embodiments of the disclosed technology.

FIG. 2 is a schematic diagram illustrating another system in accordance with embodiments of the disclosed technology.

FIG. 3 is a schematic diagram illustrating yet another system in accordance with embodiments of the disclosed technology.

FIG. 4 is a schematic diagram illustrating still another system in accordance with embodiments of the disclosed technology.

FIG. 5 is a flowchart illustrating a method in accordance with embodiments of the disclosed technology.

The drawings are not necessarily drawn to scale. For example, the dimensions of some of the elements in the figures may be expanded or reduced to help improve the understanding of various embodiments. Similarly, some components and/or operations may be separated into different blocks or combined into a single block for the purposes of discussion of some of the embodiments. Moreover, although specific embodiments have been shown by way of example in the drawings and described in detail below, one skilled in the art will recognize that modifications, equivalents, and alternatives will fall within the scope of the appended claims.

### DETAILED DESCRIPTION

In this description, references to “some embodiment,” “one embodiment,” or the like, mean that the particular feature, function, structure or characteristic being described is included in at least one embodiment of the disclosed technology. Occurrences of such phrases in this specification do not necessarily all refer to the same embodiment. On the other hand, the embodiments referred to are not necessarily mutually exclusive.

The present disclosure relates to a system that can be used to timely and properly share collected/captured images. In some embodiments, the system includes a control device (e.g., a remote control) and a corresponding camera device (e.g., a sports camera) that can be controlled by the control device. The system is easy to operate in an intuitive/straightforward fashion. The camera device includes an image component (e.g., an image sensor module and a camera lens) configured to collect images (e.g., pictures or videos). The camera device can also include a storage component (e.g., a hard drive, disk drive, flash drive, etc.) configured to store the collected images. The control device includes a share button configured to receive image-sharing instructions from a user. For example, a “single-click” of the share button can mean an instruction of sharing a collected image with others via a remote server (e.g., a server for a social media network). As another example, a “double-click” of the share button can mean another instruction of sharing a set of continuous images (e.g., a video) with others via the remote server. In some embodiments, the system can send a link of a network address or a web address to the remote server such that a viewer can access the collected images via the link (e.g., the collected images can be stored in a network-accessible database or an image server). In some embodiments, the remote server and the image server can be owned and operated by an identical entity or different entities.

In some embodiments, the system also enables the user to create a set of actions that correspond to the instructions for sharing collected images. For example, holding the share button and rotating the control device can represent an instruction to stop a current image streaming process. As another example, pressing the share button for a period of time (e.g., for 3 seconds) and then followed by a quickly double-click can represent an instruction to share collected images with a specific group of people (e.g., a “Friends” group in a social network).

In some embodiments, the share button can be a rotatable button (e.g., a control wheel or a joystick). In such embodiments, the system enables a user to rotate and/or press the share button to create various combinations of instructions regarding sharing the collected images.

The control device further includes an instruction processor configured to analyze/recognize/identify an instruction from the user by the share button. In some embodiments, the instruction processor can be a chip, a computer-executable program, a firmware, a circuit, and/or other devices that can perform similar functions. Once the instruction is identified and confirmed, the instruction can be transmitted to the camera device under a relatively short-range communication protocol (e.g., Bluetooth, infrared, wireless local area network (WLAN), IEEE 802.11u, Hotspot protocols, etc.). In some embodiments, the control device can include an encoder to encode the instruction before transmitting it to the camera device (e.g., for security needs). In such embodiments, the camera device can include a corresponding decoder to decode the encoded instruction before processing it.

After confirming/verifying the instructions, the camera device can then transmit the collected images to a remote server (e.g., an image server, a social network server, etc.) according to the received instructions. The collected images will be transmitted to the remote server under a relatively long-range communication protocol (e.g., 3G/4G LTE, WiMAX, IEEE 802.16e, etc.), and then the collected images can be shared with others in the way particularly instructed by the user. By this arrangement, the system enables the user to timely and properly share collected images with others in a convenient way.

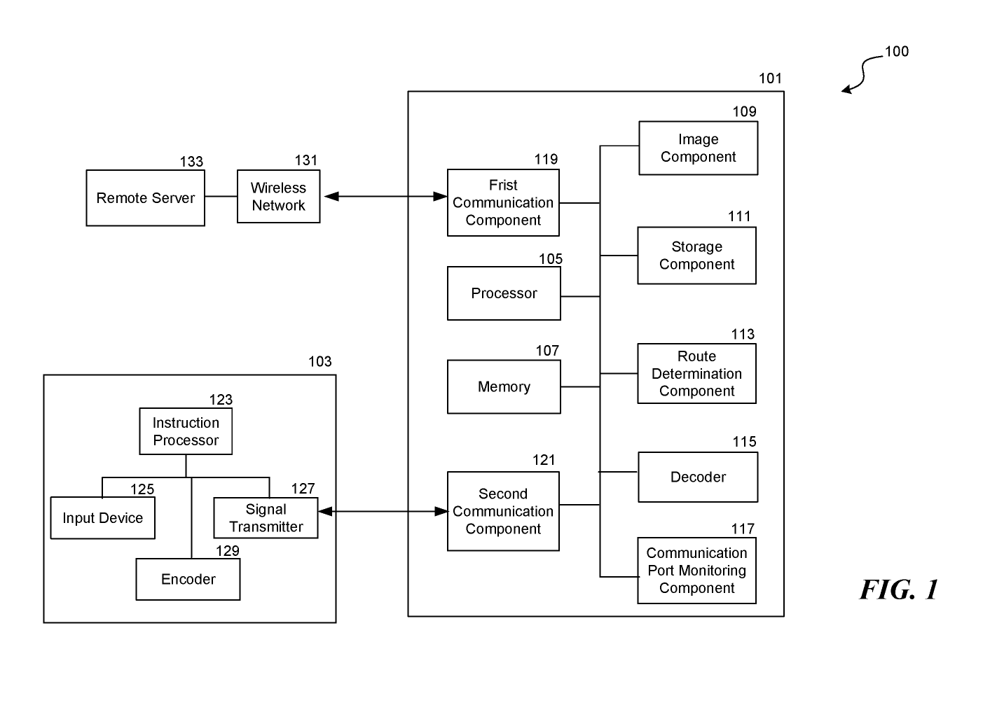

FIG. 1 is a schematic diagram illustrating a system 100 in accordance with embodiments of the disclosed technology. The system 100 includes a sports camera 101 and a remote control 103. The system 100 can communicate with a remote server 133 (e.g., a social network server, an image-sharing server, an image database, and/or other suitable servers) via a wireless network 131. The sports camera 101 includes a processor 105, a memory 107, an image component 109, a storage component 111, a route determination component 113, a decoder 115, a communication port monitoring component 117, a first communication component 119, and a second communication port component 121. The processor 105 is configured to control the memory 107 and other components (e.g., components 109-121) in the system 100. The memory 107 is coupled to the processor 105 and configured to store instructions for controlling other components or other information in the system 100.

The image component 109 is configured to capture or collect images (pictures, videos, etc.) from ambient environments of the system 100. For example, the image component 109 can collect images associated with an object-of-interest. Examples of the object-of-interest include creatures or items such as a person, a wild animal, a vehicle, a vessel, an aircraft, a sports item, etc. In some embodiments, the image component 109 can include an image sensor and a lens. In some embodiments, the image component 109 can be a video recorder. The storage component 111 is configured to store, temporarily or permanently, information/data/files/signals associated with the system 100. In some embodiments, the storage component 111 can be a hard disk drive. In some embodiments, the storage component 111 can be a memory stick or a memory card. In some embodiments, the storage component 111 can be configured to store a set of user settings (e.g., a list of social media websites to share the collected image).

The first communication component 119 is configured to communicate with the remote server 113 via the wireless network 131 under a first communication protocol (e.g., a relatively long-range communication protocol). The second communication component 121 is configured to communicate with the remote control 103 under a second communication protocol (e.g., a relatively short-range communication protocol). The first communication component 119 has a first maximum communication range greater than a second maximum communication range of the second communication component 121. Advantages of having two separate, designated communication components include better energy efficiency (e.g., communicating under the relatively short-range protocol consumes less energy than under the relatively long-range communication protocol) and better communication quality (e.g., having separate communication channels can avoid potential communication interference).

The route determination component 113 is configured to determine which route the first communication component 119 is going to use to communicate with the remote server 133. For example, in some embodiments, the first communication component 119 is capable of communicating with the remote server 133 via a 3G communication, a 4G communication, or a Wi-Fi communication. The route determination component 113 can analyze all possible communication routes based on availability, communication quality, expenses, reliability, etc. and then make a recommendation to a user of the system 100. The user can then select a communication route based on the recommendation. In some embodiments, the route determination component 113 can automatically select a communication route for the system 100, based on a set of pre-determined criteria (e.g., quality first, lowest expenses, or personal preference, etc.).

Similarly, the route determination component 113 can also determine which route the second communication component 121 is going to use to communicate with the remote control 103. For example, in some embodiments, the second communication component 121 is capable of communicating with the remote control 103 via a Bluetooth communication, an infrared communication, etc. The route determination component 113 can analyze all possible communication routes based on availability, communication quality, reliability, proximity, etc. The route determination component 113 can also make a recommendation to a user or automatically select a communication route for the user based on pre-determined criteria. This arrangement provides flexibility of communication and therefore enhances overall system efficiency.

The communication port monitoring component 117 is configured to monitoring a status of the communication between the sports camera 101 and the remote control 103. In some embodiments, the sports camera 101 and the remote control 103 can communicate via a designated communication port. In some embodiments, a user can design a private communication protocol to designate a particular communication port to be exclusively used by a certain device (e.g., the remote control 103 in this embodiment). In such embodiments, the communication port monitoring component 117 can periodically or continuously monitor the status (e.g., normal or abnormal) of the designated communication port so as to make sure that the sports camera 101 and the remote control 103 can properly and timely communicate with each other. In some embodiments, the communication port monitoring component 117 can also monitor the communication between the sports camera 101 and the remote server 133. In such embodiments, the result of the monitoring can be considered by the route determination component 113 when it determines which route to use for communicating with the remote server 133.

As shown in FIG. 1, the remote control 103 includes an instruction processor 123, an input device 125, a signal transmitter 127, and an encoder 129. The input device 125 is configured to receive an instruction from a user. In some embodiments, the input device 125 can be a physical button. In some embodiments, the input device 125 can be a virtual button. In some embodiments, the input device 125 can be other suitable devices that enable the user to intuitively enter his/her instructions by a simple action such as a movement, a rotation, a click, etc. In some embodiments, for example, a “clicking” action can include hitting, pressing, pushing and/or touching. The instructions are associated with actions (e.g., to share, live-stream, or grant access to certain files or images) to be taken regarding images stored in the storage component 111 or images collected by the image component 109.

Once the user enters the instruction, the instruction processor 123 can analyze the instruction and then identify a corresponding action. For example, the instruction processor 123 can determine that the instruction is “to share an image file” by identifying that the user's input was a “single-click” on the input device. As another example, the instruction processor 123 can determine that the instruction is “to share a set of images via a server” by identifying that the user's input was a “double-click” on the input device. The signal transmitter 127 can then generate a signal based on the identified instruction and then transmit the generated signal to the second communication component 121 of the sports camera 101 for further process.

To provide suitable data security, the encoder 129 of the remote control 103 can encode the generated signal based on a set of rules (e.g., encryption, algorithms, etc.) before sending it to the sports camera 101. After receiving the encoded signal, the decoder 115 of the sports camera 101 can decode the encoded signal based on the same set of rules.

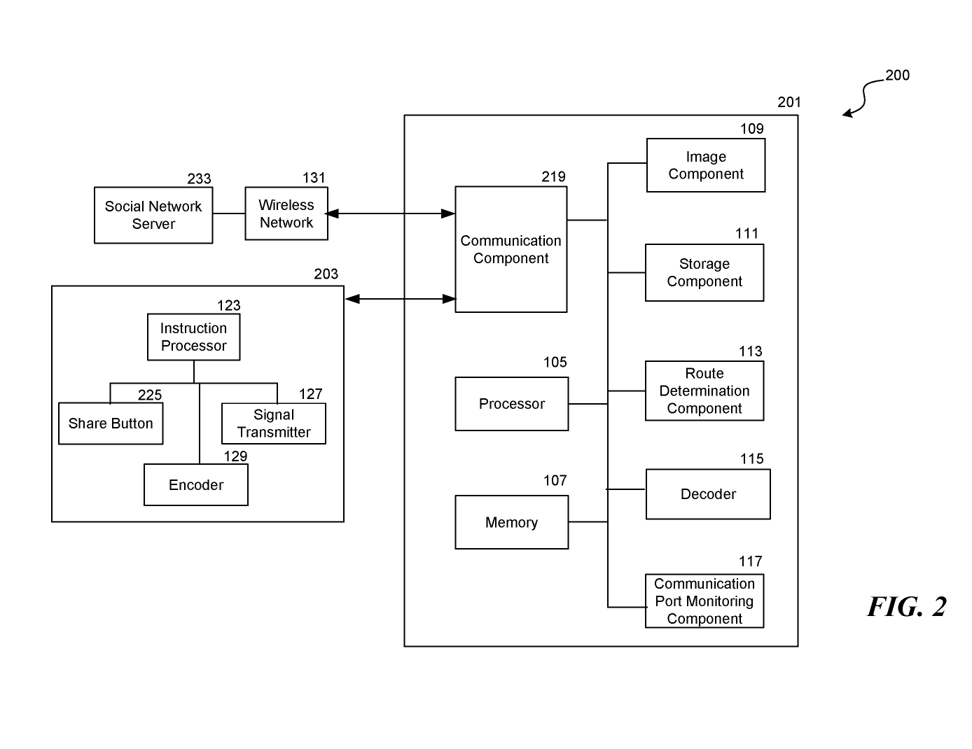

FIG. 2 is a schematic diagram illustrating another system 200 in accordance with embodiments of the disclosed technology. As shown, the system 200 includes a camera 201 and a controller 203. The system 200 can communicate with a social network server 233 via a wireless network 131. The camera 201 includes a processor 105, a memory 107, an image component 109, a storage component 111, a route determination component 113, a decoder 115, a communication port monitoring component 117, and a communication component 219. The processor 105 is configured to control the memory 107 and other components (e.g., components 109-219) in the system 200. The memory 107 is coupled to the processor 105 and configured to store instructions for controlling other components or other information in the system 200.

The image component 109 is configured to capture or collect images (still pictures, videos, etc.) from ambient environments of the system 200. In some embodiments, the image component 109 can include an image sensor and a lens. In some embodiments, the image component 109 can be a video recorder. The storage component 111 is configured to store, temporarily or permanently, information/data/files/signals associated with the system 200. In some embodiments, the storage component 111 can be a hard disk drive. In some embodiments, the storage component 111 can be a memory stick or a memory card.

The communication component 219 is configured to (1) communicate with the social network server 233 via the wireless network 131 under a first communication protocol (e.g., a relatively long-range communication protocol); and (2) communicate with the controller 203 under a second communication protocol (e.g., a relatively short-range communication protocol). In such embodiments, the communication component 219 can be an integrated chip/module/component that is capable of communicating with multiple devices (e.g., the social network server 233 and the controller 203) under multiple communication protocols. Advantages of having one integrated communication components include having a simple design and may potentially reduce the overall size of the system 200.

The route determination component 113 is configured to determine which route the communication component 219 is going to use to communicate with the social network server 233 or the controller 203. The route determination component 113 can analyze all possible communication routes based on availability, communication quality, expenses, reliability, proximity, etc. and then make a recommendation to a user of the system 200. The user can then select a communication route based on the recommendation. In some embodiments, the route determination component 113 can automatically select a communication route for the user, based on pre-determined criteria (e.g., quality first, lowest expenses, or personal preference, etc.). This arrangement provides flexibility of communication and therefore enhances overall system efficiency.

The communication port monitoring component 117 is configured to monitoring the communication between the camera 201 and other devices (e.g., the social network server 233 or the controller 203). In some embodiments, the camera 201 and the controller 203 can communicate via a designated communication port. In such embodiments, the communication port monitoring component 117 can periodically or continuously monitor the status (e.g., normal or abnormal) of the designated communication port so as to make sure that the camera 201 and the controller 203 can properly and timely communicate with each other.

In some embodiments, the communication port monitoring component 117 can also periodically or continuously monitor the communication between the camera 201 and the social media server 233. In such embodiments, the communication port monitoring component 117 can verify whether the communication therebetween is established based on desirable security requirement (e.g., the social media server 233 may require the camera 201 to login or authenticate before sending files thereto). In some embodiments, the result of the monitoring can be considered by the route determination component 113 when determining which route to use for the camera 201 to communicate with other devices.

The controller 203 includes an instruction processor 123, a share button 225, a signal transmitter 127, and an encoder 129. The share button 225 is configured to receive an instruction from a user. In some embodiments, the share button 225 can be a physical button. In some embodiments, the share button 225 can be other suitable devices that enable the user to intuitively enter his/her instructions by a simple action such as a movement, a rotation, a hit, a click, etc. The instructions are associated with actions (e.g., to share, live-stream, or grant access to certain files or images) to be taken regarding images stored in the storage component 111 or images collected by the image component 109.

Once the user enters the instruction, the instruction processor 123 can analyze the instruction and then identify a corresponding action. The signal transmitter 127 can then generate a signal based on the identified instruction and then transmit the generated signal to the communication component 219 of the camera 201 for further process. To provide suitable data security, the encoder 129 of the controller 203 can encode the generated signal based on a set of rules (e.g., encryption, algorithms, etc.) before sending it to the camera 201. After receiving the encoded signal, the decoder 115 of the camera 201 can decode the encoded signal based on the same set of rules. The processor 105 of the camera 201 then analyzes the decoded signals and then identifies corresponding instructions. The camera 201 then initiates a file sharing process based on the identified instructions, as discussed above.

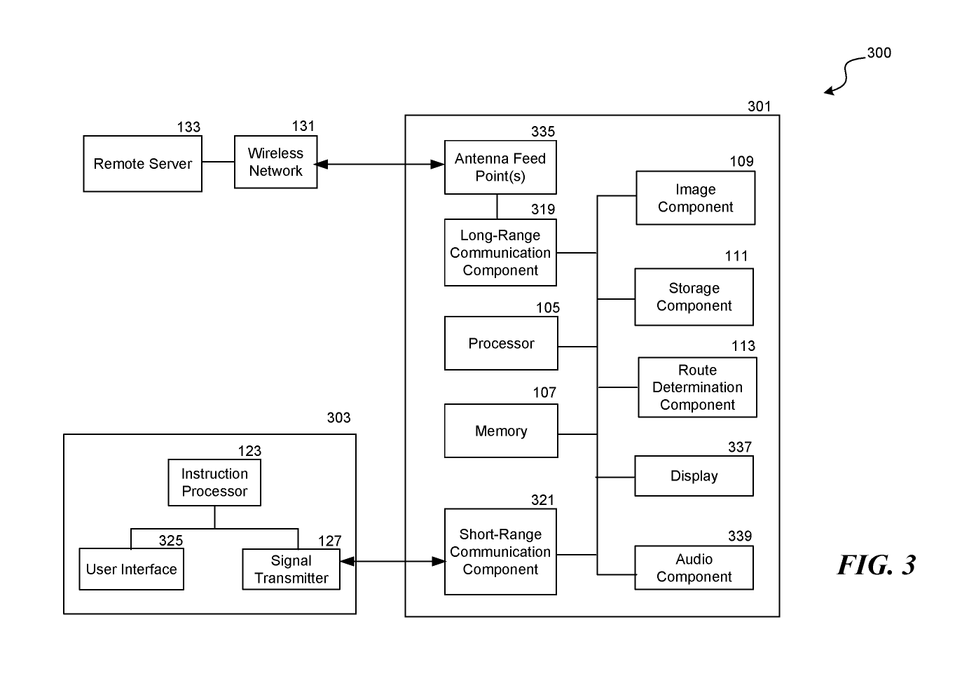

FIG. 3 is a schematic diagram illustrating a system 300 in accordance with embodiments of the disclosed technology. The system 300 includes a camera 301 and a mobile device 303. The system 300 can communicate with a remote server 133 via a wireless network 131. The camera 301 includes a processor 105, a memory 107, an image component 109, a storage component 111, a route determination component 113, a long-range communication component 319, a short-range communication component 321, an antenna feed point 335 coupled to the long-range communication component 319, a display 337, and an audio component 339. The processor 105 is configured to control the memory 107 and other components (e.g., components 109-339) in the system 300. The memory 107 is coupled to the processor 105 and configured to store instructions for controlling other components or other information in the system 300. The image component 109 is configured to capture or collect images (pictures, videos, etc.) from ambient environments of the system 300. In some embodiments, the image component 109 can include an image sensor and a lens. In some embodiments, the image component 109 can be a video recorder. The storage component 111 is configured to store, temporarily or permanently, information associated with the system 300.

The long-range communication component 319 is configured to communicate with the remote server 113 via the wireless network 131 under a first communication protocol (e.g., a relatively long-range communication protocol). The antenna feed point 335 is configured to connect the long-range communication component 319 with an external antenna so as to enhance the signal range and/or strength of the long-range communication component 319. In some embodiments, multiple antenna feed points 335 can be positioned on a housing of the camera 301 and electrically coupled to the long-range communication component 319. This configuration enables a system user to conveniently and quickly connect the camera 301 with the external antenna via the antenna feed points 335.

The short-range communication component 321 is configured to communicate with the mobile device 303 under a second communication protocol (e.g., a relatively short-range communication protocol). Advantages of having two separate, designated communication components include better emergency efficiency (e.g., communicating under the relatively short-range protocol consumes less energy than under the relatively long-range communication protocol) and better communication quality (e.g., having separate communication channels can avoid potential communication interference).

The route determination component 113 is configured to determine which route the long-range/short-range communication components 319, 321 is going to use to communicate with the remote server 133 or the mobile device 303. The route determination component 113 can analyze all possible communication routes based on availability, communication quality, expenses, reliability, proximity, etc. and then make a recommendation to a user of the system 300. The user can then select a communication route based on the recommendation. In some embodiments, the route determination component 113 can automatically select a communication route for the user, based on pre-determined criteria (e.g., quality first, lowest expenses, or personal preference, etc.). This arrangement provides flexibility of communication and therefore enhances overall system efficiency.

The display 337 is configured to visually present images to a user. In some embodiments, the display 337 can be a touchscreen display that can interact with a user. In some embodiments, the display 337 is a Liquid Crystal Display (LCD). The display 337 can also be coupled to the storage component 111 such that the display 337 can visually present the images stored in the storage component 111 to a user. The audio component 339 is configured to receive and record audio signals from surrounding environments. In such embodiments, the audio component 339 can be a microphone. In some embodiments, the audio component 339 can be configured to transmit audio signals to a user. In such embodiments, the audio component 339 can be a speaker.

The mobile device 303 includes an instruction processor 123, a user interface 325, and a signal transmitter 127. The user interface 325 is configured to receive an instruction from a user. In some embodiments, the user interface 325 can include a virtual button visually presented thereon. The user interface 325 enables the user to intuitively enter his/her instructions by a simple action such as a movement, a rotation, a hit, a click, etc. The instructions are associated with actions (e.g., to share, live-stream, or grant access to certain files or images) to be taken regarding images stored in the storage component 111 or images collected by the image component 109.

Once the user enters the instruction, the instruction processor 123 can analyze the instruction and then identify the same. The signal transmitter 127 can then generate a signal based on the identified instruction and then transmit the generated signal to the short-range communication component 321 of the camera 301 for further process. The processor 105 of the camera 301 then analyzes the transmitted signals and then identifies corresponding instructions. The camera 301 then initiates a file sharing process based on the identified instructions, as discussed above.

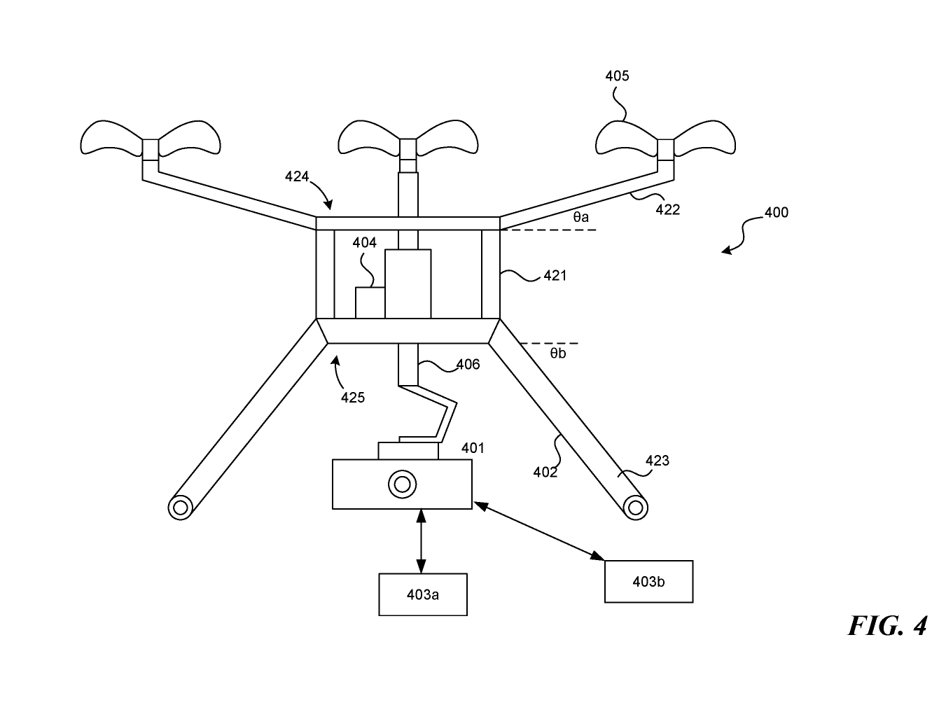

FIG. 4 is a schematic diagram illustrating a camera drone system 400 in accordance with embodiments of the disclosed technology. As shown, the camera drone system 400 includes a camera 401, a support structure 402, a first wireless controller 403a, a second wireless controller 403b, a drone controller 404, multiple rotor wings 405, and a camera connector 406. The support structure 402 includes a center frame portion 421, multiple arm components 422, and multiple leg components 423. The center frame portion 421 is configured to support the drone controller 404. In some embodiments, the drone controller 404 can be coupled to the center frame portion 421.

The arm components 422 are configured to support the rotor wings 405. In some embodiments, each arm component 422 is configured to support a corresponding one of the rotor wings 405. In some embodiments, the arm components 422 are positioned circumferentially around the center frame portion 421. As shown in FIG. 4, each of the arm components 422 is positioned to form a first angle θa with an upper surface 424 of the center frame portion 421. In other embodiments, however, individual arm components 422 can be positioned to form different first angles with the upper surface 424 of the center frame portion 421. The leg components 423 are configured to support the camera drone system 400 when it is placed on the ground. In some embodiments, the leg components 423 can be positioned so as to protect the camera 401 from possible impact caused by other objects (e.g., a bird flying near the drone camera system 400 during operation).

In some embodiments, the leg components 423 can be positioned circumferentially around the center frame portion 421. As shown in FIG. 4, each of the leg components 423 is positioned to form a second angle θ_{b} with a lower surface 425 of the center frame portion 421. In the illustrated embodiment shown in FIG. 4, the second angle θ_{b} is greater than the first angle θₐ. In other embodiments, the second angle θ_{b} can be smaller than or equal to the first angle θₐ. In some embodiments, the first angle θₐ can be about 30 degrees, and the second angle θ_{b} can be about 45 degrees.

As shown in FIG. 4, the camera device 401 is fixedly or rigidly coupled to the center frame portion 421 by the camera connector 406 (e.g., the camera device 401 does not rotate relatively to the center frame portion 421). In the illustrated embodiment, the camera connector 406 is a U-shaped member. In some embodiments, the camera connector 406 can function as a damper so as to protect the camera device 401 from undesirable vibration caused by the rotor wings 405.

The camera 401 is configured to interact with the first wireless controller 403a and a second wireless controller 403b. In the illustrated embodiment, the first wireless controller 403a can be a main controller used to control the movement of the camera drone system 400. The second wireless controller 403b can be a mobile device (e.g., a smartphone) with an application that enables an operator to initiate an image sharing process performed by the camera drone system 400 (more particularly, the camera 401).

In some embodiments, the first/second wireless controller 403a, 403b can be controlled by one operator. For example, in such embodiments, the operator can first move the camera drone system 400 to a point-of-interest by the first wireless controller 403a, and then the operator can use the second wireless controller 403b to initiate an image sharing process by clicking a button of the second remote control 403b (e.g., touch a virtual button formed on a display of the smartphone).

In other embodiments, the first/second wireless controller 403a, 403b can be operated/controlled by different operators. For example, a designated pilot can move the camera drone system 400 by the first wireless controller 403a, while an observer (e.g., a director of a film) can keep observing the images collected by the camera 401 (e.g., the collected images are periodically or continuously sent to the second wireless controller 403b for review). Then the observer can decide when to initiate an image sharing process (or stop the same). The system 400 provides flexibility regarding how to control the system 400 and also enables a user to timely and properly share collected images in an intuitive manner.

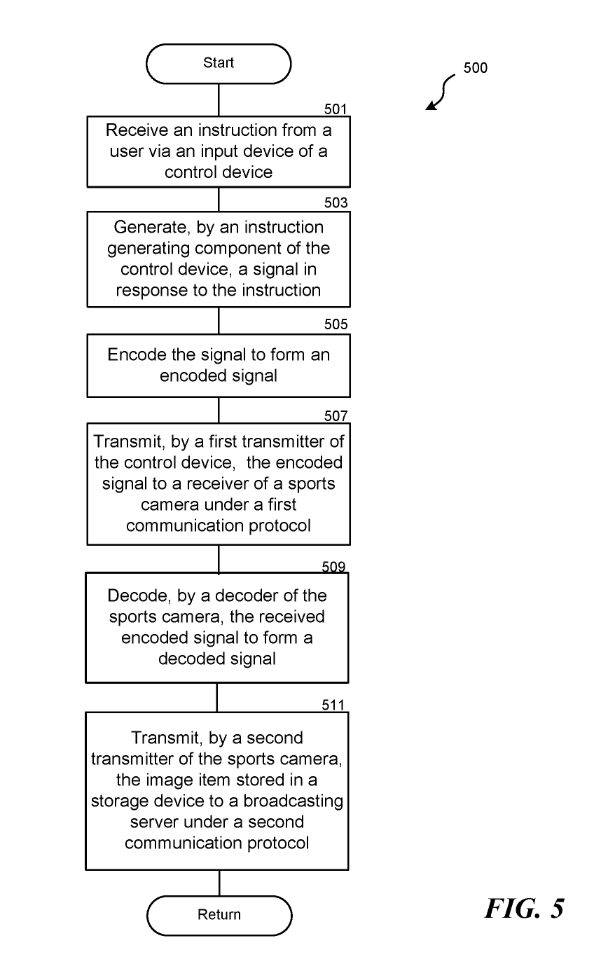

FIG. 5 is a flowchart illustrating a method 500 in accordance with embodiments of the disclosed technology. The method 500 starts at block 501 by receiving an instruction from a user via an input device of a control device. At block 503, the method 500 continues to generate, by an instruction generating component of the control device, a signal in response to the instruction. In some embodiments, the instruction generating component can be a processor that can analyze and identify instructions regarding how to handle collected images. In some embodiments, the instruction generating component can be a chip, a computer-executable program, a firmware, a circuit, and/or other devices that can perform similar functions.

At block 505, the method 500 then encodes the signal to form an encoded signal. At block 507, the method 500 transmits, by a first transmitter of the control device, the encoded signal to a receiver of a sports camera under a first communication protocol. The method 500 then continues at block 509 to decode, by a decoder of the sports camera, the received encoded signal to form a decoded signal. At block 511, the method 500 then transmits, by a second transmitter of the sports camera, the image item stored in a storage device to a broadcasting server under a second communication protocol. The method 500 then returns and waits for further instructions.

Although the present technology has been described with reference to specific exemplary embodiments, it will be recognized that the present technology is not limited to the embodiments described but can be practiced with modification and alteration within the spirit and scope of the appended claims. Accordingly, the specification and drawings are to be regarded in an illustrative sense rather than a restrictive sense.

1. A system for remotely initiating a process of granting access to an image item, the system comprising:
a control device comprising—
a share button configured to generate an instruction according to a user operation;
an instruction processor coupled to the share button and configured to generate a signal in response to the instruction;
an encoder coupled to the instruction processor and configured to encode the signal to formed an encoded signal; and
a signal transmitter coupled to the instruction processor and configured to transmit the encoded signal under a first communication protocol; and
an image-capturing device comprising—
a processor,
a first communication component coupled to the processor and configured to receive the encoded signal from the signal transmitter;
a decoder coupled to the processor and configured to decode the encoded signal to form a decoded signal, wherein the decoded signal is provided back to the processor;
a storage device coupled to the processor and configured to store the image item and user account information; and
a second communication component coupled to the processor and configured to transmit, in response to the decoded signal, the image item to a remote server according to the user account information under a second communication protocol.

2. The system of claim 1, wherein the first communication component has a first maximum communication range, and wherein the second communication component has a second maximum communication range different than the first maximum communication range.

3. The system of claim 2, wherein the first maximum communication range is smaller than the second communication distance.

4. The system of claim 1, wherein when the image item is transmitted to the remote server, the processor is further configured to acquire a web address of the image item from the remote server via the second communication component and to access a social website to post the web address via the second communication component according to the user account information.

5. The system of claim 4, wherein the social website and the remote server are owned by different entities.

6. The system of claim 4, wherein the storage component is further configure to store a set of user settings, and wherein the social website is selected from a plurality of social websites according to the user settings.

7. The system of claim 1, wherein the share button includes a physical button.

8. The system of claim 1, wherein the system further comprises:
an authentication component, coupled to the processor, configured to decide whether to enable the processor to response to the decoded signal; and
a connection control component, coupled to the first communication component, configured to decide whether to enable the first communication component to receive the encoded signal from the transmitter component.

9. The system of claim 1, wherein the image-capturing device further includes an image component coupled to the processor and configured to generate the image item, and wherein the processor is configured to control the image component to capture a real-time image as the image item when the process when the processor receives the decoded signal.

10. The system of claim 9, wherein the instruction is selected from a first instruction and a second instruction according to the user operation.

11. The system of claim 10, wherein if the first instruction is selected as the instruction, the real-time image is a still picture, and wherein if the second instruction is selected as the instruction, the real-time image is a video.

12. The system of claim 11, wherein a maximum length of the video is 15 seconds.

13. The system of claim 10, wherein the first instruction is selected by the user clicking the share button once for a period of time, and wherein the second instruction is selected by the user clicking the share button twice for the period of time.

14. A method for sharing an image item, comprising:
generating an instruction from a user operation via an input device of a control device;
generating, by an instruction generating component of the control device, a signal in response to the instruction;
encoding the signal to form an encoded signal;
transmitting, by a first transmitter of the control device, the encoded signal to a receiver of a sports camera under a first communication protocol;
decoding, by a decoder of the sports camera, the received encoded signal to form a decoded signal; and
transmitting, in response to the decoded signal, by a second transmitter of the sports camera, the image item stored in a storage device to a broadcasting server according to user account information stored in the storage device under a second communication protocol.

15. The method of claim 14, further comprising:
transmitting the encoded signal to the first signal receiver of the sports camera under a short-range communication protocol;
transmitting the image item stored in the storage device to the broadcasting server under a long-range communication protocol; and
broadcasting, by the broadcasting server, the transmitted image item based on a set of rules associated with the instruction;
capturing a real-time image as the image item according to the decoded signal.

16. The method of claim 14, further comprising:
acquiring a web address of the image item from the remote server via the second communication component; and
accessing a social website to post the web address via the second communication component according to the user account information.

17. The method of claim 16, further comprising:
storing a set of user settings; and
selecting the social website from a plurality of social websites according to the user settings.

18. The method of claim 14, wherein the input device includes a share button and the instruction is generated based on a number that the user clicks the button during a period of time, and wherein the method further comprises:
capturing a real-time still picture as the image item if the user clicks the button once during the period of time; and
capturing a real-time video as the image item if the user clicks the button twice during the period of time.

19. A method for sharing an image item, comprising:
receiving an encoded signal from a mobile device under a private communication protocol, wherein the encoded signal is generated at least based on a user input collected by an input device of the mobile device;
analyzing the encode signal to determine whether the user input is a first user input or a second input;
in an event that the encoded signal is determined as the first user input, transmitting the image item to a remote server under a first communication protocol; and
in an event that the user input is the second user input, generating a set of images associated with the image item and transmitting the set of images to the remote server under a second communication protocol.

20. The method of claim 19, further comprising:
receiving the encoded signal by a first signal receiver under a short-range communication protocol;
transmitting the image item or the set of images associated with the image item to the remote server under a long-range communication protocol; and
analyzing the encode signal by decoding the encoded signal.
